(19) United States
(12) Patent Application Publication
(10) Pub. No.: US 2015/0212584 A1
(43) Pub. Date: Jul. 30, 2015

(54) IN-VEHICLE INPUT DEVICE

(71) Applicant: HONDA MOTOR CO., LTD., Tokyo (JP)

(72) Inventor: Hirokazu Aoyama, Wako-shi (JP)

(73) Assignee: HONDA MOTOR CO., LTD., Tokyo (JP)

(21) Appl. No.: 14/603,562

(22) Filed: Jan. 23, 2015

(30) Foreign Application Priority Data
Jan. 29, 2014 (JP) 2014-014376

(51) Int. Cl. G06F 3/01; G06F 3/041; G06T 7/00; G06F 3/0346

(52) U.S. Cl. CPC G06F 3/017; G06F 3/0346; G06F 3/041; G06T 7/004; G06T 2207/30201

(57) ABSTRACT

An in-vehicle input device includes a mechanism to detect the approach direction of a finger and tilt a touch panel in the right-left direction. If an operation input part representing at least one of the forearm and the hand of an occupant moves closer to the touch panel and enters a second region that is closer to the occupant, the operation input part is detected by a detection sensor. An ECU moves the touch panel so that the touch panel turns toward the direction of the operation input part. If the operation input part further moves closer to the touch panel and enters a first region, the ECU stops the movement of the touch panel.

### CROSS REFERENCES TO RELATED APPLICATIONS

The present application claims priority under 35 U.S.C. §119 to Japanese Patent Application No. 2014-014376, filed Jan. 29, 2014, entitled “In-vehicle Input Device.” The contents of this application are incorporated herein by reference in their entirety.

### TECHNICAL FIELD

The present disclosure relates to an in-vehicle input device including a touch panel display (hereinafter referred to as a “touch panel”) that displays information and detects a finger of an occupant contacting the surface.

### BACKGROUND

Recently, a navigation device and/or a display audio device of vehicles has included a touch panel so as to display information and allow an occupant to perform an input operation with his/her finger.

In general, to increase ease of operation performed on a touch panel by an occupant (a driver and a front seat passenger), the touch panel is disposed and fixed to a dashboard of the vehicle in the middle or substantially middle in the vehicle width direction.

An input operation on a touch panel disposed and fixed to a dashboard is performed by an occupant (a driver and a front passenger) sitting on a seat. Accordingly, due to a positional relationship between the installation location of the touch panel and the occupant, the operation needs to be performed in a diagonal direction. Thus, the viewability and operability of the touch panel are degraded.

Japanese Patent No. 5334618 describes a technology to increase the viewability of the display of the touch panel and the operability when an input operation is performed on the touch panel.

That is, Japanese Patent No. 5334618 describes a technology in which a tilt mechanism is provided to tilt (rotate) a touch panel to the right or left in the horizontal direction and, if the touch panel detects the direction in which the finger approaches thereto, the tilt mechanism is driven so that the direction of the touch panel is changed (tilted) toward the direction in which the finger approaches thereto (refer to paragraph [0034] and paragraphs [0037] to [0040] of Japanese Patent No. 5334618).

### SUMMARY

However, according to the technology described in Japanese Patent No. 5334618, if an operating finger direction determination unit detects the direction in which the finger approaches thereto, the touch panel is moved to tilt toward the approach direction of the finger. After the tilt movement starts, the touch panel is still tilted to the right or left until the finger is brought into contact with the touch panel. Thus, ease of the operation performed on the touch panel by the occupant decreases.

Accordingly, the present application provides an in-vehicle input device that includes a mechanism to turn a touch panel toward the approach direction of a finger of an occupant and that is capable of increasing ease of operation of the touch panel performed by the occupant without decreasing the ease of operation.

According to an aspect of the present disclosure, an in-vehicle input device mounted in a vehicle and operable by an occupant is provided. The device includes a touch panel configured to display information thereon and sense input from contact with a finger of the occupant, a drive unit configured to be capable of turning the touch panel toward at least a vehicle width direction, a detection sensor configured to detect at least one of a forearm and a hand of the occupant as an operation input part, and a control unit configured to control the drive unit in response to detection by the detection sensor. The detection sensor detects whether the operation input part of the occupant is present in a first region and/or a second region defined between the occupant and the touch panel, where the first region is located at a predetermined distance from the touch panel and the second region is located at a predetermined distance from the first region in a direction toward the occupant. If the detection sensor detects that the operation input part is present within the second region, the control unit controls the drive unit to turn the touch panel toward a direction of the operation input part. If the detection sensor detects that the operation input part is present within the first region, the control unit stops controlling the drive unit.

According to the aspect of the disclosure, if the operation input part, which is at least one of the forearm and the hand of the occupant, moves towards the touch panel and enters the second region close to the occupant, the detection sensor detects the operation input part. If the operation input part is detected, the control unit drives the drive unit to move the touch panel toward the vehicle width direction so that the touch panel turns toward the direction of the operation input part. When the operation input part further moves closer to the touch panel and enters the first region, the control unit instructs the drive unit to stop turning the touch panel toward the vehicle width direction. Thus, the movement of the touch panel is stopped. Through such control, ease of operation performed on the touch panel by the occupant can be increased.

In such a case, it is desirable that the detection sensor detect a direction of an extended line of the forearm of the occupant and the control unit control the drive unit so that the touch panel is substantially perpendicular to the direction of the extended line of the forearm as viewed from above the vehicle.

In this manner, the touch surface of the touch panel is substantially perpendicular to the forearm of the occupant. Accordingly, ease of operation performed by the occupant with the finger thereof is increased. Note that the term “forearm” refers to the structure of the limb from the wrist to the elbow.

In such a case, it is desirable that if the detection sensor detects that the hand is not present in the first region and the second region after detecting that the hand is present in the second region, the control unit cause the touch panel to return to an original position prior to being driven.

In this manner, if the touch operation performed by the occupant is completed, the touch panel can be returned to the original position before the rotational drive (the home position). Accordingly, an occupant other than the occupant who performed the touch operation can also easily view information displayed on the touch panel without any unpleasant feelings. Note that as described above, the term “hand” refers to the structure of the limb from the wrist to the fingertip.

In such a case, it is desirable that the detection sensor further detects one of the face direction and the line of sight of the occupant and, if the detection sensor determines that one of the face direction and the line of sight is directed toward the touch panel, the control unit do not allow the touch panel to return to an original position prior to being driven even when the detection sensor detects that the hand is not present in the first region and the second region after detecting that the hand is present in the second region.

If it is estimated that the face direction and the line of sight of the occupant is oriented toward the touch panel, the touch panel is not returned to the original position even when the hand moves out of the first region and the second region. In this manner, during when the occupant is attempting to operate the touch panel, the touch surface of the touch panel is being directed to the occupant. Thus, ease of operation on the touch surface performed by the occupant can be increased and, therefore, the occupant who attempts to operate the touch panel and views the touch panel does not have unpleasant feelings.

In addition, it is desirable that if the detection sensor detects, in the first region, a predetermined gesture made by the hand for stopping driving the touch panel and locking the touch panel, the control unit do not allow the touch panel to return to an original position prior to being driven even when the detection sensor detects that the hand is not present in the first region and the second region after detecting that the hand is present in the second region.

When the occupant makes a predetermined gesture with the hand thereof in this manner, the touch panel is not returned to the original position even when the hand moves out of the regions. Thus, during a period of time during which the occupant wants to perform an operation, the touch panel continues to be directed to the occupant. Thus, ease of operation on the touch panel performed by the occupant can be increased more, and the occupant does not have unpleasant feelings.

In addition, it is desirable that when the occupant operates a touch screen of the touch panel with a finger thereof and if the detection sensor detects that a second hand representing a hand of a second occupant other than the occupant is present in the second region, the control unit performs control so that the drive unit does not operate in response to movement of the second hand of the second occupant after the detection sensor detects that the second hand is present in the second region until the detection sensor detects that the second hand is not present in the first region and the second region.

In this manner, even when a second occupant attempts to operate the touch panel while the occupant is operating the touch panel, the touch panel does not move. As a result, the operation performed on the touch panel by the occupant is not interfered.

Furthermore, it is desirable that the in-vehicle input device further include a seat position sensor configured to detect a position of a seat occupied by the occupant in the front-rear direction of the vehicle, and the control unit vary at least one of the sizes of the first region and the second region in accordance with the position of a seat detected by the seat position sensor.

By varying at least one of the sizes of the first region and the second region on the basis of the seat position detected by the seat position sensor in this manner, the first region and the second region appropriate for the operation input part (at least one of the forearm and the hand of the occupant) of the occupant currently sitting on the seat can be set. Note that if the seat position sensor is not provided, the position of the head of the occupant may be measured by using the detection sensor or another detection sensor. In this manner, at least one of the sizes of the first region and the second region may be made variable.

Still furthermore, it is desirable that the control to turn the touch panel toward the direction of the operation input part be enabled only when the direction of the extended line of the forearm of the occupant is toward the touch panel.

If the direction of the extended line of the forearm of the occupant is not directed to the touch panel, it is highly likely that the occupant operates another operation unit disposed in the vicinity of the touch surface of the touch panel. Accordingly, in such a case, the touch panel is not allowed to rotationally move. In this manner, the occurrence of unpleasant feelings of the occupant can be prevented in advance.

According to the present disclosure, for an in-vehicle input device including a drive unit that detects the direction of the approach direction of a finger and turns the touch panel toward the vehicle width direction, ease of operation performed on the touch panel by an occupant of the vehicle does not decrease.

More specifically, if the operation input part, which is at least one of the forearm and the hand of the occupant, moves towards the touch panel and enters the second region closer to the occupant, the detection sensor detects the operation input part. If the operation input part is detected, the control unit drives the drive unit to move the touch panel toward the vehicle width direction so that the touch panel turns toward the direction of the operation input part. When the operation input part further moves closer to the touch panel and enters the first region, the control unit instructs the drive unit to stop turning the touch panel toward the vehicle width direction. Thus, the movement of the touch panel is stopped. Through such control, ease of operation performed on the touch panel by the occupant can be increased.

### BRIEF DESCRIPTION OF THE DRAWINGS

The advantages of the disclosure will become apparent in the following description taken in conjunction with the following drawings.

FIG. 1 is a block diagram schematically illustrating the configuration of an in-vehicle input device according to an exemplary embodiment.

FIG. 2 is a plan view schematically illustrating a front seat section of a vehicle having the in-vehicle input device mounted therein as viewed from above.

FIG. 3 illustrates the structures of the limb including the hand and the forearm.

FIG. 4 illustrates the rotation axis of the touch panel.

FIG. 5 is a plan view schematically illustrating control regions in the front seat section of the vehicle having the in-vehicle input device illustrated in FIG. 1 as viewed from above.

FIG. 6 is a flowchart of the operation performed in a first process.

FIG. 7A illustrates an operation input part that is not within the first and second regions; FIG. 7B illustrates the operation input part that is within the second region; and FIG. 7C illustrates the operation input part that is within the first region.

FIG. 8 illustrates an example of a distance information screen that describes the vector of the forearm.

FIG. 9 is a flowchart of the operation performed in a second process.

FIG. 10A illustrates the touch panel that is oriented toward one direction and that does not move even when the operation input part enters from the other direction; and FIG. 10B illustrates the touch panel that turns toward the direction of one operation input part when the other operation input part that previously operates moves away from first and second regions.

FIG. 11A illustrates the touch panel operated by a first operator; FIG. 11B illustrates the first operator who makes a gesture for locking the touch panel in one of operation regions; FIG. 11C illustrates the touch panel that is locked even when the operation input part of the first operator moves out of the operation region; FIG. 11D illustrates the touch panel that turns its direction when the operation input part of the second operator enters another operation region; and FIG. 11E illustrates the touch panel that is returned to the position locked by the first operator after the operation input part of the second operator moves out of the other operation region.

### DETAILED DESCRIPTION

An in-vehicle input device according to an exemplary embodiment of the present disclosure is described in detail below with reference to the accompanying drawings.

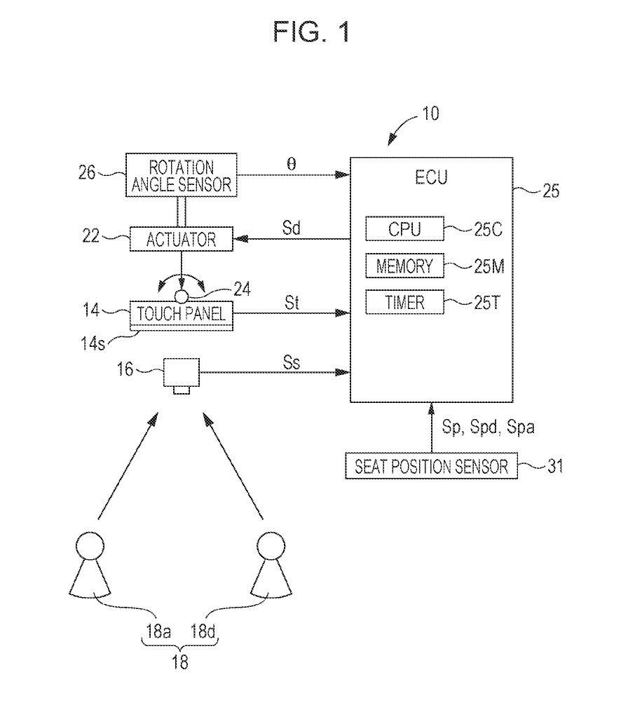

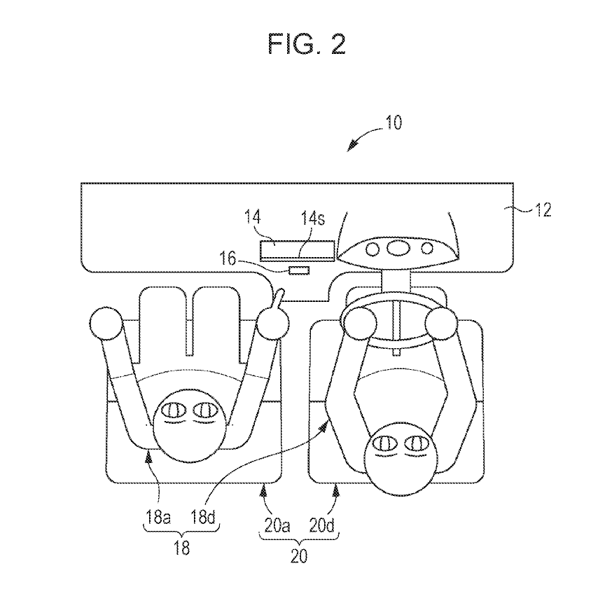

FIG. 1 is a block diagram schematically illustrating the configuration of an in-vehicle input device 10 according to an exemplary embodiment. FIG. 2 is a plan view schematically illustrating a front seat section of a vehicle having the in-vehicle input device 10 mounted therein as viewed from above.

As illustrated in FIGS. 1 and 2, the in-vehicle input device 10 includes a touch panel 14 disposed on a dashboard (an instrument panel) 12 in substantially the middle of the width of the vehicle and a detection sensor 16 disposed under the touch panel 14. The touch panel 14 is formed from a liquid crystal display having a touch surface 14s. The detection sensor 16 detects, for example, the hand, forearm, face direction, line of sight, and head of an occupant 18.

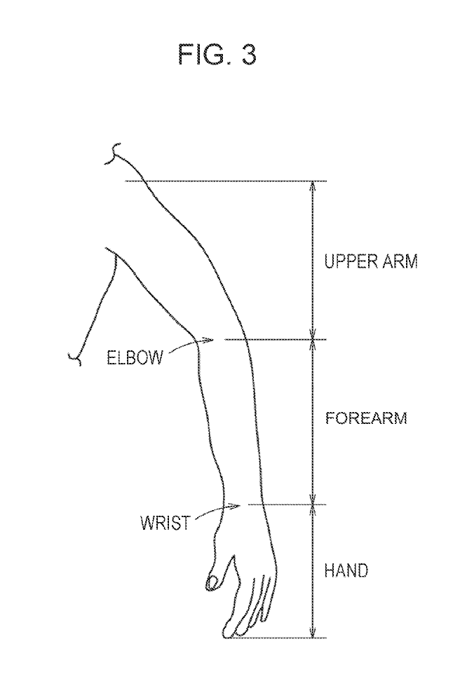

Note that as illustrated in FIG. 3, the term “forearm” refers to a body part from the wrist to the elbow, and the term “hand” refers to a body part from the wrist to the fingertip.

The touch panel 14 displays information and detects the finger of an occupant contacting the surface. For example, as the touch panel 14, a display unit of a navigation device that displays a route superimposed on a road map or a display audio device that can communicate with a smart phone may be used.

A depth camera is used as the detection sensor 16. However, the detection sensor 16 is not limited to a depth camera. For example, a scanning radar sensor, a combination of an electrostatic sensor that can measure a distance and a normal camera, or a stereo camera can be used as the detection sensor 16.

For example, in the case of a depth camera, the detection region of the detection sensor 16 corresponds to the image capturing range (the view angle) of the camera. The detection region is set to a region including a region from the vicinity of the touch surface 14s of the touch panel 14 to the upper body (including the limb and the face) of an occupant 18d (a driver sitting on a driver's seat 20d according to the present exemplary embodiment) and a region from the vicinity of the touch surface 14s to the upper body of an occupant 18a (an occupant sitting on a front passenger seat 20a).

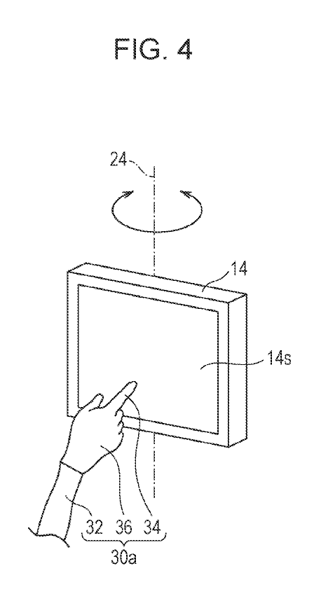

As illustrated in FIGS. 1 and 4, the touch panel 14 can be tilted (rotated) about a rotation axis 24 extending in substantially the vertical direction in the right-left direction (the horizontal direction) by an actuator 22 serving as a drive unit including, for example, a speed reducer and a motor. That is, the touch surface 14s, which is a front surface of the touch panel 14, can be directed toward the vehicle width direction by the actuator 22. A tilt angle θ of the touch panel 14 from the home position to the right or left (in the vehicle width direction) is detected by a rotation angle sensor 26. The rotation angle sensor 26 is formed from an encoder attached to the touch panel 14 or the actuator 22. Note that the home position of the touch panel 14 is a position at which the touch surface 14s turns toward the rear of the vehicle or slightly turns toward the occupant 18d.

The in-vehicle input device 10 further includes an electronic control unit (ECU) 25 serving as a control unit.

The ECU 25 is a computer including a microcomputer. The ECU 25 further includes a central processing unit (CPU) 25C, a memory 25M formed as a read only memory (ROM) (including an electrically erasable programmable read-only memory (EEPROM)) and a random access memory (RAM), input and output units, such as an A/D converter and a D/A converter, and a timer 25T serving as a time measuring unit or a time measuring device. The CPU 25C reads a program stored in the memory 25M, such as a ROM, and executes the program. In this manner, the ECU 25 functions as a variety of function realizing units. For example, the ECU 25 functions as a control unit, a computing unit, and a processing unit.

The ECU 25 detects a tile angle θ using the rotation angle sensor 26, a touch signal St indicating a time of finger contact, a time of finger lift, and the position of touch detected by the touch panel 14, a detection signal Ss for the forearm and the hand (the finger) using the detection sensor 16, and a seat position detection signal Sp using a seat position sensor 31 (a driver seat position detection signal Spd and a front passenger seat position detection signal Spa) using the seat position sensor 31. In addition, the ECU 25 drives the actuator 22 to tilt the touch panel 14 by setting and controlling, for example, the tile angle θ of the touch panel 14 on the basis of these detection signals. The functions implemented by the ECU 25 may be embodied by another hardware such as a circuitry or a control module.

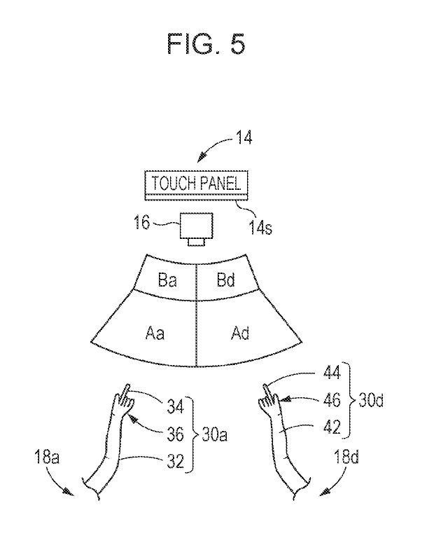

FIG. 5 is a plan view schematically illustrating the front seat section of the vehicle having the in-vehicle input device 10 illustrated in FIG. 1 as viewed from above.

As illustrated in FIG. 5, a forearm 32 and a hand 36 (including and a finger 34) of the right arm of the occupant 18a who sits on the front passenger seat 20a (refer to FIG. 2) function as an operation input part 30a of the occupant 18a. In addition, a forearm 42 and a hand 46 (including a finger 44) of the left arm of the occupant 18d who sits on the driver's seat 20d function as an operation input part 30d of the occupant 18d.

FIG. 5 illustrates a space domain (a space region or a control region) that the ECU 25 defines as a control region thereof by referring to the detection signal Ss of the detection sensor 16. Note that by referring to the detection signal Ss, the ECU 25 can detect or determine the positions and postures of the operation input parts 30a and 30d located in first regions Ba and Bd and second regions Aa and Ad (described in more detail below) and the position and posture of the operation input parts 30a and 30d located outside the above-described regions. Examples of the regions outside first regions Ba and Bd and second regions Aa and Ad include the vicinity of the touch panel 14 and the vicinity of the touch surface 14s on the inner side from the first regions Ba and Bd (on the side close to the dashboard 12) and the vicinity of the driver's seat 20d and the vicinity of a backrest of the front passenger seat 20a on the outer side from the second regions Aa and Ad.

The first region Ba located at a predetermined distance from the touch panel 14 and the second region Aa located at a predetermined distance from the first region Ba in a direction toward the occupant 18a are defined as a monitoring region (a control region) of the ECU 25 on the front passenger side. In addition, the first region Bd located at a predetermined distance from the touch panel 14 and the second region Ad located at a predetermined distance from the first region Bd in a direction toward the occupant 18d are defined as a monitoring region (a control region) of the ECU 25 on the driver's seat side. The size of the monitoring region (the control region) can be increased and decreased by the ECU 25 on the basis of a predetermined setting operation performed on the touch panel 14 by the occupant 18 or the seat position detection signal Sp detected by the seat position sensor 31 (described in more detail below).

The ECU 25 can detect whether each of the regions (the first regions Ba and Bd and the second regions Aa and Ad) contains each of the operation input part 30a of the occupant 18a and the operation input part 30d of the occupant 18d on the basis of the detection signal Ss output from the detection sensor 16.

According to the present exemplary embodiment, the border line extending between a pair consisting of the first region Ba and the second region Aa and a pair consisting of the first region Bd and the second region Ad coincides with a center axis line that divides the width of the vehicle in half. However, the setting of the border line can be changed as needed in accordance with the direction of the touch panel 14 located at the home position and the installation positions of the driver's seat 20d and the front passenger seat 20a. The home position of the touch panel 14 is defined as the position of the touch panel 14 when the touch surface 14s is directed toward the rear center of the vehicle. At that time, the ECU 25 recognizes that the tile angle θ=0. Note that instead of setting the tile angle θ to 0, the home position of the touch panel 14 may be slightly offset toward the driver's seat 20d.

The operation performed in the above-described exemplary embodiment is described below.
First Process: (a process performed until the operation input part 30a is moved closer to the touch panel 14 and is brought into contact with the touch panel 14 (including a touch operation))

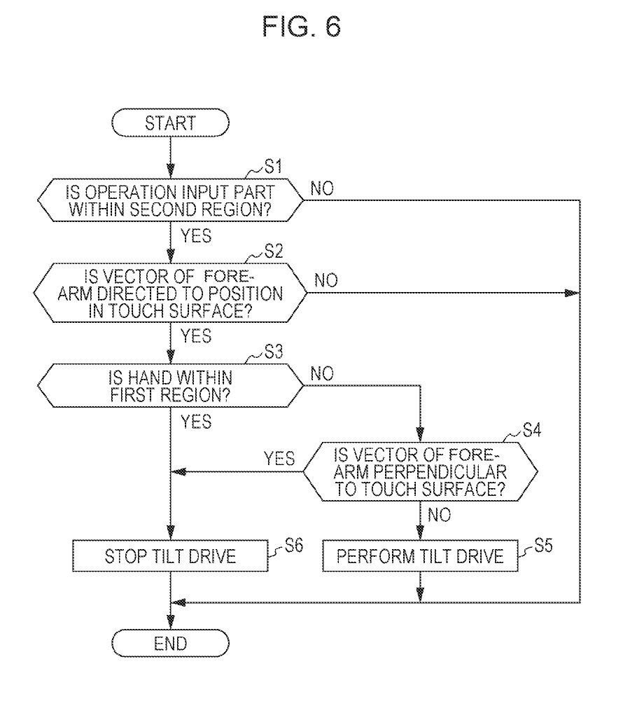

FIG. 6 is a flowchart of the operation performed in the first process. A program corresponding to the flowchart is executed by the ECU 25 (more precisely, the CPU 25C of the ECU 25).

For simplicity and for ease of understanding, the first process is described with reference to only the occupant 18a sitting on the front passenger seat 20a.

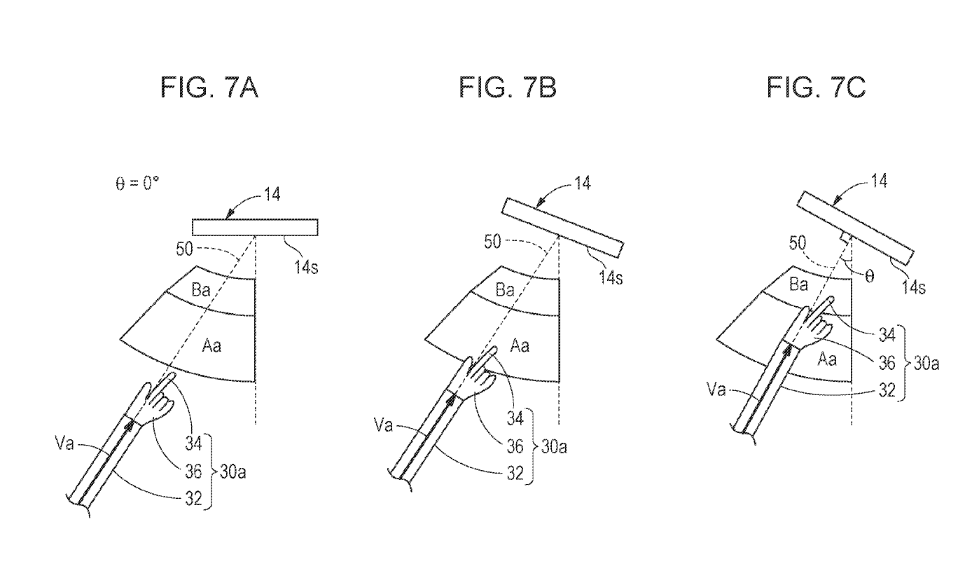

In step S1, the ECU 25 detects whether the operation input part 30a (part of the operation input part 30a) of the occupant 18a is present in the second region Aa using the detection signal Ss of the detection sensor 16. As illustrated in FIG. 7A, if the operation input part 30a is not present (NO in step S1), the processing returns to step S1.

If, as illustrated in FIG. 7B, the ECU 25 detects that the operation input part 30a is present in the second region Aa (YES in step S1), it is detected whether a direction 50 of a vector Va of the forearm 32 is within the range of the touch surface 14s (i.e., whether the vector Va is directed toward the touch surface 14s) in step S2.

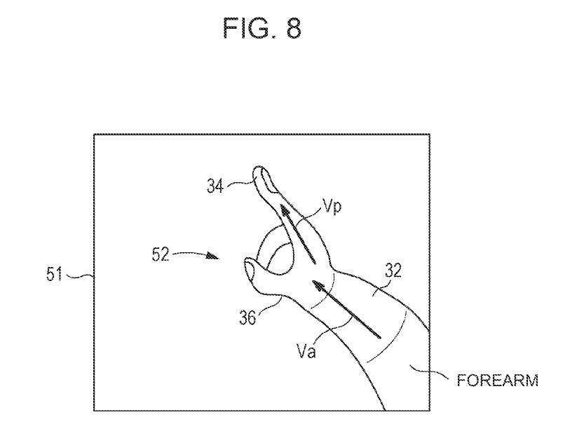

Note that the vector Va of the forearm 32 can be obtained from an image 52 displayed in a distance information screen 51 illustrated in FIG. 8. Since the distance between the forearm 32 and the detection sensor 16 increases toward the lower right end of the image 52, a line extending between the elbow and the wrist of the forearm 32 can be detected as the vector Va. Note that if the forearm 32 is located within a distance range for operating the touch panel 14, the elbow and the wrist are bent. Accordingly, in general, the direction of the vector Va of the forearm 32 differs from the direction of a vector Vp indicating the direction of the finger 34.

If the direction 50 of the vector Va of the forearm 32 is outside the range of the touch surface 14s (NO in step S2), the processing returns to step S1.

As illustrated in FIG. 7B, when the operation input part 30a is present in the second region Aa and if the direction 50 of the vector Va of the forearm 32 is within the range of the touch surface 14s (YES in step S2), it is further detected whether the hand 36 including the finger 34 is present in the first region Ba in step S3.

If the hand 36 is not present in the first region Ba (NO in step S3), that is, when the operation input part 30a (including the hand 36) is present in the second region Aa and the direction 50 of the vector Va of the forearm 32 is within the range of the touch surface 14s and if the hand 36 is not present in the first region Ba (refer to FIG. 7B), it is detected whether the direction 50 of the vector Va of the forearm 32 is perpendicular to the touch surface 14s as viewed from above the vehicle on the basis of the detection signal Ss output from the detection sensor 16 and the tile angle θ output from the rotation angle sensor 26 in step S4.

If the determination in step S4 is negative (NO in step S4), that is, if the direction 50 of the vector Va of the forearm 32 is not perpendicular to the touch surface 14s as viewed from above the vehicle, the actuator 22 is driven using a drive signal Sd in step S5. Thus, the touch panel 14 is driven to tilt (rotate) about the rotation axis 24 in the vehicle width direction while following the forearm 32 so that the direction 50 of the vector Va of the forearm 32 is perpendicular to the touch surface 14s as viewed from above the vehicle.

Thereafter, the processes of step S1 (YES), step S2 (YES), step S3 (NO), step S4 (NO), and step S5 are repeated. If the determination in step S4 is affirmative (YES in step S4), that is, if the direction 50 of the vector Va of the forearm 32 is perpendicular to the touch surface 14s as viewed from above the vehicle (refer to FIG. 7C), driving of the touch panel 14 to tilt (driving in a follow-up mode) is stopped, and the touch panel 14 is locked in step S6.

Note that in order to stop driving the touch panel 14 to tilt and lock the touch panel 14, when the hand 36 is present in the first region Ba and if a predetermined gesture is made in front of the touch panel 14 (e.g., the hand 36 makes a fist, that is, a touch-panel-14 locking gesture is made), the driving of the touch panel 14 to tilt may be stopped, and the touch panel 14 may be locked. Alternatively, a lock button and an unlock button may be provided on the touch panel 14.

As described above, when the operation input part 30a (the hand 36) enters the second region Aa, the touch panel 14 is driven to tilt so that the touch surface 14s of the touch panel 14 is perpendicular to the direction 50 of the vector Va of the forearm 32 as viewed from above the vehicle. When the operation input part 30a (the hand 36) enters the first region Ba, the driving of the touch panel 14 to tilt is stopped and the movement of the touch panel 14 is inhibited (the touch panel 14 is set in a lock mode). Accordingly, when the hand 36 (the finger 34) further moves closer to the touch surface 14s, the touch panel 14 is not driven to tilt, since the touch panel 14 is set in a lock mode when the operation input part 30a is in the first region Ba. As a result, the touch panel 14 is not driven to tilt anymore and, thus, a touch operation performed on the touch surface 14s with the tip of the finger 34 is facilitated.

That is, according to the present exemplary embodiment, when the occupant 18a (18d) operates the touch panel 14 with the hand 36 (46) and the finger 34 (44), the movements of the hand 36 (46), the finger 34 (44), and the forearm 32 (42) toward the touch panel 14 are sensed. Before the finger 34 (44) is brought into contact with the touch panel 14, the movements of the hand 36 (46), the finger 34 (44), and the forearm 32 (42) of the occupant 18a (18d) in a direction towards the touch surface 14s are detected, and the touch panel 14 is driven to tilt so as to be directed to the occupant 18a (18d). In addition, if a distance between the tip of the finger 34 (44) and the touch surface 14s is small, driving of the touch panel 14 to tilt is stopped. Thus, the touch panel 14 is locked with the touch panel 14 facing the occupant 18a (18d). Thereafter, by bringing the tip of the finger 34 (44) in contact with the touch surface 14s, a touch operation can be performed on the touch surface 14s of the touch panel 14 that is locked with the touch panel 14 facing the occupant 18a (18d). In this manner, the touch operation is facilitated.
Second Process: (a process performed when the operation input part 30a (the finger 34) in contact with the touch panel 14 is lifted from the touch panel 14)

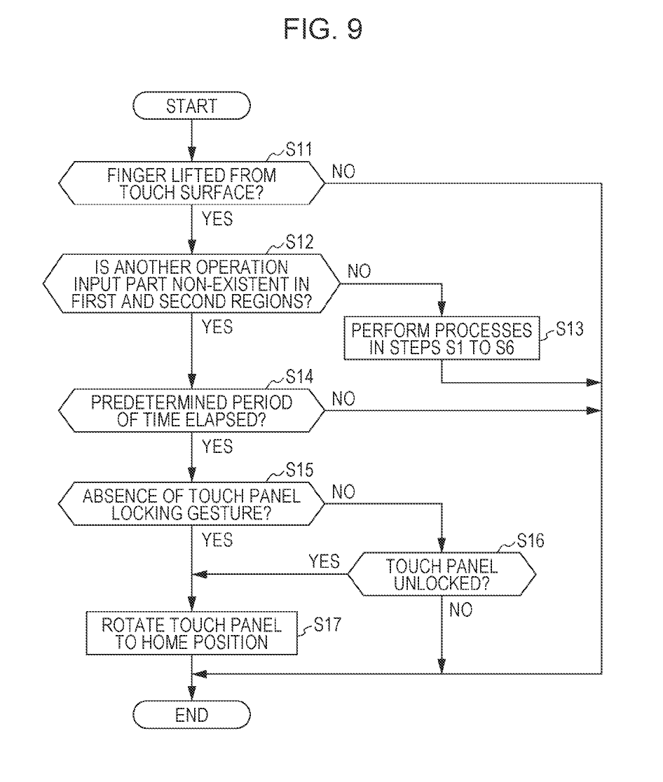

FIG. 9 is a flowchart of the operations performed in the second process.

In step S11, it is detected whether the finger 34 is lifted from the touch surface 14s on the basis of the touch signal St or the detection signal Ss. If the finger 34 is not lifted (NO in step S11), the processing returns to step S11.

If it is detected that the finger 34 is lifted from the touch surface 14s (YES in step S11), it is further detected whether the operation input part 30d is present in the first region Bd or the second region Ad using the detection signal Ss in step S12. Note that when the finger 34 of the operation input part 30a is lifted from the touch surface 14s, the timer 25T starts measuring an elapsed time.

If, in step S12, the operation input part 30d is detected in the first region Bd or the second region Ad using the detection signal Ss (NO in step S12), the above-described processes in steps S1 to S6 are performed in step S13 for the operation input part 30d.

However, if, in step S12, it is detected that the operation input part 30d is non-existent in the first region Bd and the second region Ad using the detection signal Ss (YES in step S12), it is determined whether the elapsed time measured by the timer 25T after the finger 34 is lifted from the touch surface 14s is greater than or equal to a predetermined period of time (a threshold time) Tth in step S14.

If the elapsed time is not greater than or equal to the predetermined period of time Tth (NO in step S14), the processing returns to step S11.

However, if the elapsed time is greater than or equal to the predetermined period of time Tth (YES in step S14), it is determined in step S15 whether the above-described touch panel locking gesture, such as a fist, is absent.

If the touch panel locking gesture is not absent (NO in step S15), it is determined whether the touch panel 14 is unlocked (stoppage of the tilt drive is released) in step S16.

If lock of the touch panel 14 is not unlocked (NO in step S16), the processing returns to step S11.

To unlock the touch panel 14, a pointing gesture made by the finger 34 after the above-described touch panel locking gesture may be used. Alternatively, the operation performed on an unlock button (not illustrated) may be used. In addition, if the touch panel 14 is not unlocked after a predetermined period of time has elapsed, the occupant 18 may be prompted to perform a predetermined unlock operation using sound emanated from an in-car speaker (not illustrated) or a message displayed on the touch panel 14.

If the touch panel locking gesture for the touch panel 14 is absent (YES in step S15) or the touch panel 14 is unlocked (YES in step S16), the touch panel 14 is driven to tilt to the home position (at a tile angle θ of 0 in FIG. 7C, i.e., the position illustrated in FIG. 7A) in step S17. Thereafter, the processing proceeds to step S1.

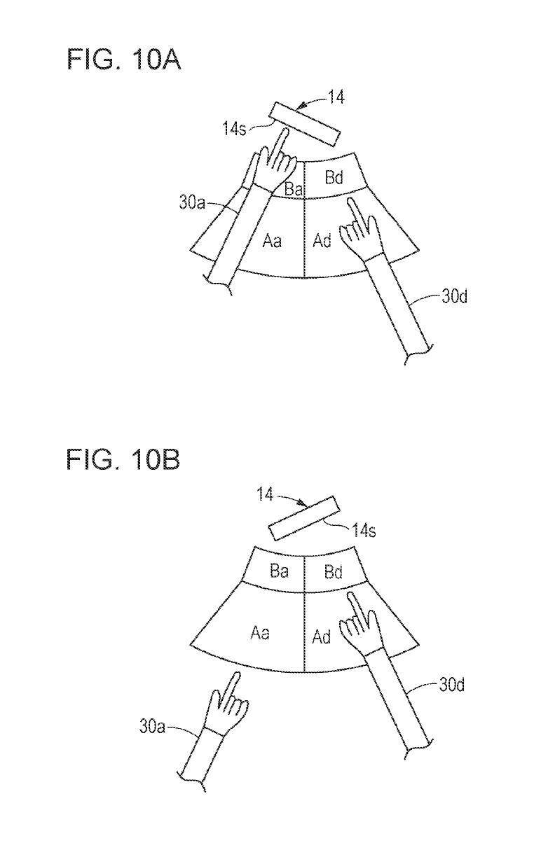

In such a case, as illustrated in FIG. 10A, when the touch panel 14 turns toward the direction of the operation input part 30a (one of the input operation parts) and if the touch panel 14 is attempted to be operated by the operation input part 30d (the other operation input part), the touch panel 14 does not move.

Thereafter, if the operation input part 30a that previously performs the operation moves away from the first region Ba and the second region Aa (NO in step S12), the touch panel 14 turns toward the direction of the operation input part 30d (the other operation input part) without returning to the home position (step S13), as illustrated in FIG. 10B. Accordingly, conflict between two operations of the touch panel 14 can be eliminated. In addition, the right to operate the touch panel 14 can be promptly granted to the occupant 18d.

### Summary and Modification of Embodiment

As described above, according to the above-described exemplary embodiment, the in-vehicle input device 10 is disposed in a vehicle so as to be operated by the occupant 18 (18a, 18d).

The in-vehicle input device 10 includes the touch panel 14 that can display information thereon and sense input from contact with the finger 34 (44) of the occupant 18a (18d), the actuator 22 serving as a drive unit capable of turning the touch panel 14 toward at least the vehicle width direction, the detection sensor 16 that detects at least one of the forearm 32 (42) and the hand 36 (46) of the occupant 18a (18d) as the operation input part 30a (30d), and the ECU 25 serving as a control unit that controls the actuator 22 in response to detection performed by the detection sensor 16.

Note that according to the exemplary embodiment, the actuator 22 drives the touch panel 14 to rotate (tilt) about the rotation axis 24 that coincides with the central axis of the touch panel 14 that extends in the substantially vertical direction of the vehicle so that the touch panel 14 (the touch surface 14s of the touch panel 14) can be turned toward the vehicle width direction.

In such a case, the detection sensor 16 detects whether the operation input part 30a (30d) of the occupant 18a (18d) is present in the first region Ba (Bd) and the second region Aa (Ad) defined between the occupant 18a (18d) and the touch panel 14, where the first region Ba (Bd) is located at a predetermined distance from the touch panel 14 and the second region Aa (Ad) is located at a predetermined distance from the first region Ba (Bd) in a direction toward the occupant 18a (18d).

If the detection sensor 16 detects that the operation input part 30a (30d) is present within the second region Aa (Ad), the ECU 25 controls the actuator 22 to turn the touch panel 14 toward the direction of the operation input part 30a (30d). In contrast, if the detection sensor 16 detects that the operation input part 30a (30d) is present within the first region Ba (Bd), the ECU 25 stops controlling the actuator 22 (as a result, the touch panel 14 is locked by the actuator 22).

As described above, if the operation input part 30a (30d), which is at least one of the forearm 32 (42) and the hand 36 (46) of the occupant 18a (18d), moves in a direction of the touch panel 14 and enters the second region Aa (Ad) that is closer to the occupant 18a (18d), the detection sensor 16 detects the operation input part 30a (30d). If the operation input part 30a (30d) is detected, the ECU 25 drives the actuator 22 to rotate the touch panel 14 about the rotation axis 24 so that the touch panel 14 turns towards the direction of the operation input part 30a (30d). If the operation input part 30a (30d) further moves closer to the touch panel 14 and enters the first region Ba (Bd), the ECU 25 instructs the actuator 22 to stop driving the touch panel 14. Thus, the rotation (the movement) of the touch panel 14 is stopped. Through such control, ease of the operation performed on the touch panel 14 by the occupant 18a (18d) can be increased.

In the exemplary embodiment, it is desirable that the detection sensor 16 detect the direction of the extended line of the forearm 32 (42) of the occupant 18a (18d) (e.g., the direction of the vector Va of the forearm 32) and the ECU 25 control the actuator 22 so that the touch panel 14 is substantially perpendicular to the direction of the extended line of the forearm 32 (42) as viewed from above the vehicle.

In this manner, the touch surface 14s of the touch panel 14 is made substantially perpendicular to the forearm 32 (42) of the occupant 18a (18d). Thus, ease of the operation performed on the touch surface 14s by the occupant 18a (18d) using the finger 34 (44) can be increased. Note that as described above, the forearm 32 (42) is defined as part of the limb between the wrist and the elbow.

In the exemplary embodiment, if, after detecting that the hand 36 (46) is present in the second region Aa (Ad), the detection sensor 16 detects that the hand 36 (46) is not present in the first region Ba (Bd) and the second region Aa (Ad), it is desirable that the ECU 25 cause the touch panel 14 to return to an original position prior to being driven (i.e., the home position).

In this manner, if the touch operation performed by the occupant 18a (18d) is completed, the touch panel 14 can be returned to the original position before being rotationally driven (the home position). Accordingly, the occupant (e.g., the occupant 18d) other than the occupant who performed the touch operation (i.e., the occupant 18a) can also easily view information displayed on the touch panel 14 without any unpleasant feelings. Note that as described above, the hand 36 (46) is defined as part of the limb from the wrist to the tip of the finger 34 (44).

In the exemplary embodiment, it is desirable that the detection sensor 16 further detect the face direction and the line of sight of the occupant 18a (18d) and, if the ECU 25 determines that one of the face direction and the line of sight of the occupant 18a (18d) is oriented toward the touch panel 14, the ECU 25 do not allow the touch panel 14 to return to the original position prior to being driven (the home position) even when the detection sensor 16 detects that the hand 36 (46) is not present in the first region Ba (Bd) and the second region Aa (Ad) after detecting that the hand 36 (46) is present in the second region Aa (Ad).

If it is estimated that one of the face direction and the line of sight of the occupant 18a (18d) is oriented toward the touch panel 14, the touch panel 14 is not returned to the original position (the home position) even when the hand 36 (46) moves out of the first region Ba (Bd) and the second region Aa (Ad). In this manner, during when the occupant 18a (18d) is attempting to operate the touch panel 14, the touch surface 14s of the touch panel 14 is continuously directed to the occupant 18a (18d). Thus, ease of operation performed on the touch surface 14s by the occupant 18a (18d) can be increased and, therefore, the occupant 18a (18d) who attempts to operate the touch panel 14 and views the touch panel 14 does not have unpleasant feelings.

Note that the face direction and the line of sight of the occupant 18a (18d) can be detected using a widely used technique. For example, a video camera is disposed next to the detection sensor 16, and the central point and the right and left end points of the face are detected on the basis of the face image output from the video camera. Thereafter, the face of the occupant 18a (18d) is approximated to, for example, a cylinder shape on the basis of the detection results, and the face direction is calculated. Subsequently, the gaze position of the occupant 18a (18d) is detected. In this manner, the face direction can be detected. To detect the line of sight of the occupant 18a (18d), the position of the pupil in the eye of the occupant 18a (18d) is detected. Thus, the direction of the pupil, that is, the sight line position can be detected.

In addition, when the detection sensor 16 detects a predetermined gesture made by the hand 36 (46) in the first region Ba (Bd) to stop the rotation of the touch panel 14 and lock the touch panel 14, it is desirable that the ECU 25 do not allow the touch panel 14 to return to the original position prior to being driven even when the detection sensor 16 detects that the hand 36 (46) is not present in the first region Ba (Bd) and the second region Aa (Ad) after detecting that the hand 36 (46) is present in the second region Aa (Ad).

As described above, when the occupant 18a (18d) makes a predetermined gesture with the hand 36 (46) thereof, the touch panel 14 is not allowed to return to the original position even when the hand 36 (46) moves out of the regions. In this manner, during a period of time during which it is estimated that the occupant 18a (18d) wants to perform an operation, the touch panel 14 continues to be directed to the occupant 18a (18d). Thus, ease of operation performed on the touch panel by the occupant 18a (18d) can be increased more, and the occupant 18a (18d) does not have unpleasant feelings.

Furthermore, when the occupant 18a operates the touch surface 14s of the touch panel 14 with the finger 34 and if the detection sensor 16 determines that the hand 46, which is the hand 46 of the occupant 18d other than the occupant 18a, is present in the second region Ad, it is desirable that the ECU 25 perform control so that the actuator 22 does not operate in response to the movement of the hand 46, which is the hand of the occupant 18d other than the occupant 18a, after detecting that the hand 46 is present in the second region Ad until the detection sensor 16 detects that the hand 46 is not present in the first region Bd and the second region Ad.

In this manner, even when the occupant 18d attempts to operate the touch panel 14 while the occupant 18a is operating the touch panel 14, the touch panel 14 does not move. As a result, the operation performed on the touch panel 14 by the occupant 18a is not interfered.

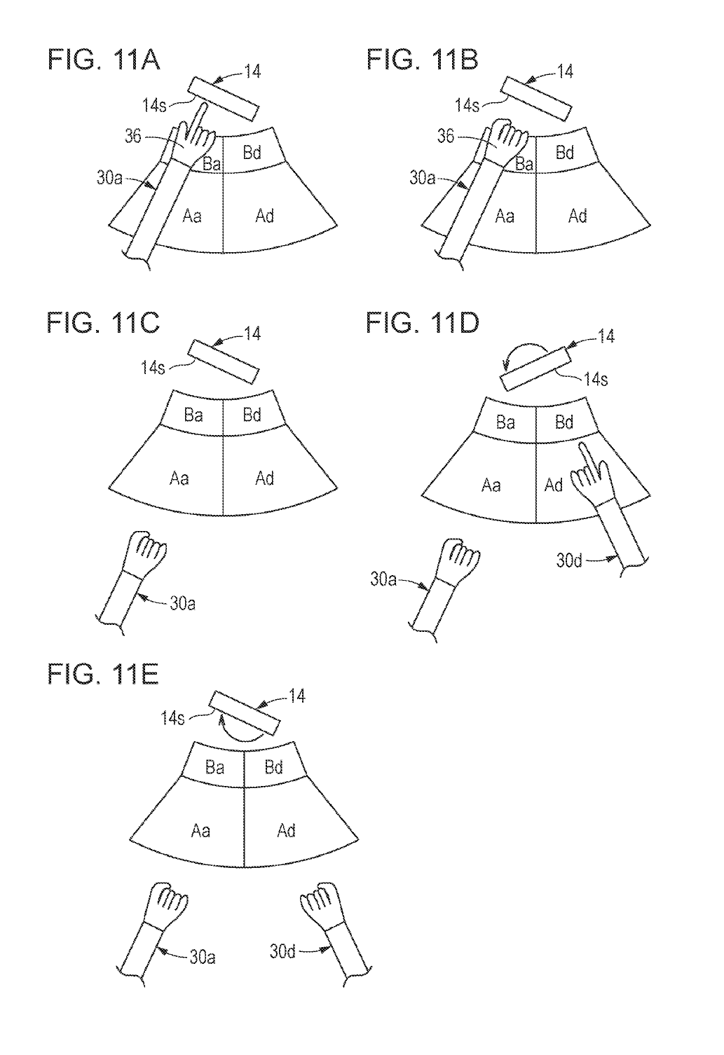

A modification for more increasing the ease of touch panel operation without interference between the operation input part 30a of the occupant 18a and the operation input part 30d of the occupant 18d is described next with reference to FIGS. 11A to 11E. According to the modification, when the occupant 18a (a first operator) and the occupant 18d (a second operator) alternately operate the touch panel 14, the direction of the touch panel 14 is changed more coordinately.

In FIG. 11A, the touch panel 14 is operated by the operation input part 30a of the occupant 18a which is present in the first region Ba and the second region Aa (one of operation ranges). The touch panel 14 is directed toward the operation input part 30a of the occupant 18a.

At that time, as illustrated in FIG. 11B, if the detection sensor 16 detects a predetermined gesture (a fist) made by the hand 36 of the occupant 18a in the first region Ba, the ECU 25 instructs the actuator 22 to lock the touch panel 14 with the touch panel 14 being directed toward the operation input part 30a.

Subsequently, as illustrated in FIG. 11C, even when the operation input part 30a of the occupant 18a moves out of the first region Ba and the second region Aa, the touch panel 14 is continuously locked.

Subsequently, as illustrated in FIG. 11D, if the detection sensor 16 detects that the operation input part 30d of the occupant 18d (the second operator) enters the first region Bd and the second region Ad (the other operation range), the ECU 25 drives the actuator 22 to tilt the touch panel 14 in the counterclockwise direction indicated by an arrow so that the touch panel 14 is perpendicular to the operation input part 30d of the occupant 18d as viewed from above the vehicle. Thereafter, the ECU 25 receives an operation input to the touch panel 14 performed by the operation input part 30d.

Finally, as illustrated in FIG. 11E, if the operation input part 30d of the occupant 18d who completed his/her operation moves out of the first region Bd and the second region Ad, the ECU 25 instructs the actuator 22 to tilt the touch panel 14 in the clockwise direction indicated by an arrow so that the direction of the touch panel 14 is returned to the direction of the operation input part 30a of the occupant 18a illustrated in FIG. 11B, and the touch panel 14 is locked.

Through the control illustrated in FIGS. 11A to 11E, the occupant 18a (more precisely, the operation input part 30a of the occupant 18a) and the occupant 18d (more precisely, the operation input part 30d of the occupant 18d) can alternately operate the touch panel 14 in a coordinated manner with a high operability without the occurrence of interference between the operations performed by the occupants 18a and 18d while, for example, the occupant 18a and the occupant 18d talk with each other.

As described above, the seat position sensor 31 is provided to detect the positions of the front passenger seat 20a, which is occupied by the occupant 18a, and the driver's seat 20d, which is occupied by the occupant 18d, in the front-rear direction of the vehicle. It is desirable that the ECU 25 vary at least one of the sizes of the first region Ba (Bd) and the second region Aa (Ad) on the basis of the seat positions based on the seat position detection signal Sp output from the seat position sensor 31.

By varying at least one of the sizes of first region Ba (Bd) and the second region Aa (Ad) on the basis of the seat positions detected by the seat position sensor 31 in this manner (e.g., if the seat position is located on the front side, the region is decreased, as compared with the seat position located on the rear side), the first region (Ba, Bd) and the second region (Aa, Ad) appropriate for the operation input part 30a (30d) of the occupant 18a (18d) currently sitting on the front passenger seat 20a or the driver's seat 20d can be set.

Note that even when the seat position sensor 31 is not provided, the position of the head of the occupant 18a (18d) can be measured by using the detection sensor 16 or another detection sensor (e.g., the above-described video camera for detecting the line of sight). In this manner, the first regions Ba and Bd and the second region Aa and Ad appropriate for the operation input part 30a (30d) of the occupant 18a (18d) can be set.

Furthermore, it is desirable that the control to turn the touch panel 14 toward the direction of the operation input part 30a (30d) be enabled only when the direction of the extended line of the forearm 32 (42) of the occupant 18a (18d) is directed toward the touch panel 14.

If the direction of the extended line of the forearm 32 (42) of the occupant 18a (18d) is not directed toward the touch panel 14, it is highly likely that the occupant 18a (18d) operates another operation unit disposed in the vicinity of the touch surface 14s of the touch panel 14. Accordingly, in such a case, the touch panel 14 is not allowed to rotationally move. In this manner, the occurrence of unpleasant feelings of the occupant 18a (18d) can be prevented in advance.

As described above, according to the above-described exemplary embodiment, the in-vehicle input device 10 includes the actuator 22 that upon detecting the approach direction of the finger 34 (44), turns the touch surface 14s of the touch panel 14 toward the vehicle width direction so that the touch surface 14s is directed toward the approach direction of the finger 34 (44). Thus, ease of the operation performed on the touch panel 14 by the occupant 18a (18d) does not decrease.

More specifically, if the operation input part 30a (30d), which is at least one of the forearm 32 (42) and the hand 36 (46) of the occupant 18a (18d), moves towards the touch panel 14 and enters the second region Aa (Ad) closer to the occupant 18a (18d), the detection sensor 16 detects the operation input part 30a (30d). If the operation input part 30a (30d) is detected, the ECU 25 drives the actuator 22 to rotate the touch panel 14 about the rotation axis 24 toward the direction of the operation input part 30a (30d). When the operation input part 30a (30d) further moves closer to the touch panel 14 and enters the first region Ba (Bd), the ECU 25 instructs the actuator 22 to stop rotating the touch panel 14 about the rotation axis 24. Thus, the rotational movement of the touch panel 14 is stopped. Through such control, ease of operation performed on the touch panel 14 by the occupant 18a (18d) can be increased.

It should be noted that the present technology is not limited to the above-described exemplary embodiment. A variety of configurations may be employed without departing from the spirit and scope of the present disclosure. For example, while the above-described exemplary embodiment has been described with reference to control that causes the direction 50 of the vector Va of the forearm 32 to be perpendicular to the touch surface 14s as viewed from above the vehicle, control may be performed so that the direction of the vector Vp of the finger 34 is perpendicular to the touch surface 14s as viewed from above the vehicle.

What is claimed is:

1. An in-vehicle input device mounted in a vehicle and operable by an occupant, comprising:
a touch panel configured to display information thereon and sense contact by a finger of the occupant;
a drive unit configured to be capable of turning the touch panel toward at least a vehicle width direction;
a detection sensor configured to detect at least one of a forearm and a hand of the occupant as an operation input part; and
a control unit configured to control the drive unit in accordance with detection by the detection sensor,
wherein the detection sensor detects whether the operation input part of the occupant is present in a first region and/or a second region, the first region and the second region being defined between the occupant and the touch panel, the first region is located at a predetermined distance from the touch panel, and the second region is located at a predetermined distance from the first region in a direction toward the occupant, and
wherein if the detection sensor detects that the operation input part is present within the second region, the control unit controls the drive unit to turn the touch panel to be directed toward a direction of the operation input part and, if the detection sensor detects that the operation input part is present within the first region, the control unit stops controlling the drive unit.

2. The in-vehicle input device according to claim 1, wherein the detection sensor detects an extending direction of the forearm of the occupant, and
wherein the control unit controls the drive unit so that the touch panel is substantially perpendicular to the extending direction of the forearm as viewed from above the vehicle.

3. The in-vehicle input device according to claim 1, wherein if the detection sensor detects that the hand is not present in the first region and the second region after detecting that the hand is present in the second region, the control unit causes the touch panel to return to an original position prior to being driven.

4. The in-vehicle input device according to claim 3, wherein the detection sensor further detects one of a face direction and a line of sight of the occupant, and
wherein if the detection sensor determines that one of the face direction and the line of sight of the occupant is directed toward the touch panel, the control unit does not allow the touch panel to return to the original position prior to being driven even when the detection sensor detects that the hand is not present in the first region and the second region after detecting that the hand is present in the second region.

5. The in-vehicle input device according to claim 3, wherein if the detection sensor detects that a predetermined gesture is made by the hand for stopping driving the touch panel and locking the touch panel in the first region, the control unit does not allow the touch panel to return to the original position prior to being driven even when the detection sensor detects that the hand is not present in the first region and the second region after detecting that the hand is present in the second region.

6. The in-vehicle input device according to claim 1, wherein when the occupant operates a touch screen of the touch panel with a finger thereof and if the detection sensor detects that a second hand representing a hand of a second occupant other than the occupant is present in the second region, the control unit performs control so that the drive unit does not operate in response to movement of the second hand after the detection sensor detects that the second hand of the second occupant is present in the second region until the detection sensor detects that the second hand is not present in the first region and the second region.

7. The in-vehicle input device according to claim 1, further comprising:
a seat position sensor configured to detect a position of a seat occupied by the occupant in the front-rear direction of the vehicle,
wherein the control unit varies at least one of sizes of the first region and the second region in accordance with the position of the seat detected by the seat position sensor.

8. The in-vehicle input device according to claim 2, wherein the control to turn the touch panel to be directed toward the direction of the operation input part is enabled only when the extending direction of the forearm of the occupant is directed toward the touch panel.

9. The in-vehicle input device according to claim 1, wherein the first region and the second region are respectively divided into at least two regions arranged along the vehicle width direction, one for a driver and the other for a passenger on a passenger seat.

10. The in-vehicle input device according to claim 1, further comprising:
a head position sensor configured to detect a position of a head of the occupant in the front-rear direction of the vehicle,
wherein the control unit varies at least one of sizes of the first region and the second region in accordance with the position of the head detected by the head position sensor.

11. The in-vehicle input device according to claim 3, wherein the control unit determines if a predetermined time has elapsed after the hand is lifted from a surface of the touch panel, and if so, allows the touch panel to return to the original position.

12. The in-vehicle input device according to claim 2, wherein the extending direction of the forearm is a direction connecting an elbow and a wrist of the occupant.

13. A vehicle comprises the in-vehicle input device according to claim 1.

14. An in-vehicle input device mounted in a vehicle and operable by an occupant, comprising:
a touch panel configured to display information thereon and sense contact by a finger of the occupant;
a drive device configured to turn the touch panel toward at least a vehicle width direction;
a detector configured to detect at least one of a forearm and a hand of the occupant as an operation input part; and
a controller configured to control the drive device in accordance with detection by the detector,
wherein the detector detects whether the operation input part of the occupant is present in a first region and/or a second region, the first region and the second region being defined between the occupant and the touch panel, the first region is located at a first predetermined distance from the touch panel, and the second region is located at a second predetermined distance from the first region in a direction toward the occupant, and
wherein if the detector detects that the operation input part is present within the second region, the controller controls the drive device to turn the touch panel to be directed toward a direction of the operation input part and, after that, if the detector detects that the operation input part is present within the first region, the controller stops controlling the drive device.

15. A method of controlling an in-vehicle input device mounted in a vehicle and operable by an occupant, the input device comprising:
a touch panel configured to display information thereon and sense contact by a finger of the occupant;
a drive device configured to turn the touch panel toward at least a vehicle width direction;
a detector configured to detect at least one of a forearm and a hand of the occupant as an operation input part; and
a controller configured to control the drive device in accordance with detection by the detector,
wherein the detector detects whether the operation input part of the occupant is present in a first region and/or a second region, the first region and the second region being defined between the occupant and the touch panel, the first region is located at a first predetermined distance from the touch panel, and the second region is located at a second predetermined distance from the first region in a direction toward the occupant, the method comprising:
detecting by the detector if the operation input part is present within the second region, and if so, controlling by the controller the drive device to turn the touch panel to be directed toward a direction of the operation input part and, after that
detecting by the detector if the operation input part is present within the first region, and if so, stopping the controlling of the drive device.
